(19) United States
(12) Patent Application Publication
(10) Pub. No.: US 2008/0254421 A1
(43) Pub. Date: Oct. 16, 2008

(54) Psychological disability evaluation software, methods and systems

(76) Inventor: Pamela A. Warren, Monticello, IL (US)

Correspondence Address: GREER, BURNS & CRAIN, 300 S WACKER DR, 25TH FLOOR, CHICAGO, IL, 60606, US

(21) Appl. No.: 12/082,605

(22) Filed: Apr. 11, 2008

Related U.S. Application Data
(60) Provisional application No. 60/923,125, filed on Apr. 12, 2007.

(51) Int. Cl. G09B 19/00

(52) U.S. Cl. 434/236

(57) ABSTRACT

Software for psychological disability evaluation and management includes at least one user interface geared specifically toward one or more of employers, psychological professionals, physicians, private or government agencies or officials, lawyers; insurance professionals, vocational rehabilitation counselors, physical or occupational therapists, or other persons or companies involved in psychological, psycho-social, and co-morbid disability evaluation and management. The software also has a database interface for accessing a database that collects and manages information relating to potential psychological disabilities and conditions, psycho-social concerns, as well as physical co-morbid concerns of employees/claimants/insured/patients. A psychological model framework based upon evidence-based psychological diagnosis, use of objective, standardized psychological testing, and best-practice treatment guidelines is incorporated into the software. The software also includes code for generating data outputs to help users evaluate and manage psychological, psycho-social, and co-morbid physical disability according to the psychological model framework in view of data collected by the database and interface.

### PRIORITY CLAIM AND REFERENCE TO RELATED APPLICATION

The application claims priority under 35 U.S.C. §119 from prior provisional application Ser. No. 60/923,125, which was filed Apr. 12, 2007.

### FIELD

A field of the invention is psychological disability evaluation and management. Another field is medical disability evaluation and management.

Another field of the invention is professional/professional assistant software.

### BACKGROUND

Psychological disability is a huge cost to society. The review of professional literature has demonstrated 300%+ increases in psychological disability claims over the past 2 decades. Unfortunately, most businesses, medical and mental health professionals are either unaware of the impact of psychological issues in the workplace and personal life, or choose to ignore them, in an effort to avoid or reduce business, medical, and mental health costs. Both of these strategies lead to ineffective evaluation and management of psychological claims and increased business, medical and mental health costs. Regrettably, the most common means of handling workplace or personal life psychological issues is placing an employee/individual/patient/insured on open-ended, long-term disability leave for psychological and/or co-morbid physical problems. The literature is clear in that the longer the employee/individual/patient/insured is off of work, the less likely it is that the employee/individual/patient/insured will ever return to work. Therefore, psychological disability is already a major concern since it is a significant cost to businesses, as well as the medical and mental health field. There is a greater cost to the individual and society since psychological disability leads to a decrease in quality of life.

There are three main ways in which psychological disability impacts on business: 1) Direct long-term psychological disability claims with true psychiatric/psychological diagnoses that have been supported by objective, standardized psychological testing; 2) Physical claims in which there are psychological issues that impede the employee's/individual's/insured's/claimant's/patient's return to work; and 3) Psycho-social workplace or personal life issues that are misrepresented as psychiatric/psychological diagnoses.

There are a few companies or professionals that have or use software that partially addresses psychological disability evaluation, assessment, treatment, and focusing on both the return to work and re-gaining of functioning. Typical products fail to use evidence-based treatments or best practice standards and objective, standardized psychological tests to evaluate the validity of a psychological disability claim. Moreover, none of the existing software identifies high-risk elements for true risk management of a psychological or co-morbid physical disability claim or address the differentiation of psycho-social issues from physical or psychological concerns. Companies and organizations that provide some psychological management strategies also have been out-sourcing of services to one or more of the other organizations. The outsourcing tends to perpetuate the lack of standardization, and renders evaluation and management of psychological disability claims inconsistent and inefficient. Efforts at providing software related to psychological conditions are typically directed toward the patient-professional model or toward management of a medical professional's office. Currently, there isn't any type of software available that addresses concurrent psychological and physical concerns or psycho-social issues.

An example is U.S. Pat. No. 6,334,778, which discloses a software system to help with assessing and monitoring psychological conditions. The system is designed to permit remote diagnosis between a professional and a patient, and the patients are prompted to interact with the system remotely. An interactive diagnostic assessment procedure provides a health care professional with information that is helpful to determine whether clinical therapy and/or medication may be required.

Another example is found in U.S. Pat. No. 6,047,259, which discloses a software system for managing a health care practice that includes interactive software tools for conducting a physical exam, suggesting tentative diagnosis, and managing a treatment protocol. Directed toward a professional user, the 259 patent guides a user through a physical exam, prompting the user for input and dynamically generating context sensitive questions based on prior input. Lists of possible diagnoses can be presented to the user and can be interactively selected.

U.S. Pat. No. 5,835,897 provides a software system that could be useful to identify inefficient and cost-ineffective health care providers based upon collected data. U.S. Pat. No. 7,008,378 aids a professional in developing a medical diagnosis and treatment plan and for documenting the effects of the treatment plan.

The art demonstrates that software is typically used to aid diagnosis and to provide a structured framework that enables a professional to promote thoroughness and avoid errors. Most often, this is for medical conditions. There remains a need for a comprehensive solution for a psychological disability evaluation, assessment, and management of co-morbid psychological and physical concerns management, identifying psycho-social issues that are not true psychiatric concerns, as well as identifying risk management issues within the software method and system. Moreover, no existing software identifies issues within a claim that are risk management elements indicative of the claim and treatment process extending past the normal anticipated time/treatment frame to the employer, treating professional, insurer, attorney, and federal and state agencies. These risk management flags provide a way to clearly focus on specific concerns that impede obtaining appropriate treatment, ascertain issues with psychological testing that may not support a claim, and specific issues, such as lack of objective data supporting the claim and psycho-social issues that are not true mental health diagnoses. While software has been used for checklists for assisting treatment in various in person and remote situations, it is believed that there is no comprehensive solution that has a focus on managing employee, patient, or insured mental health disabilities, and providing a framework according to best practice and objective assessment psychological guidelines for assisting employees, employers, doctors (including all mental health professionals), lawyers, insurance providers and the like.

### SUMMARY OF THE INVENTION

An embodiment of the invention is computer software for psychological disability evaluation and management including at least one user interface geared specifically toward one or more of an employer, a psychological professional, a physicians, a private or government agency or official, a lawyer, an insurance professional, a vocational rehabilitation counselor, a physical or occupational therapist, or another person or company involved in psychological, psycho-social, and co-morbid disability evaluation and management. The software also has a database interface for accessing a database that collects and manages information relating to potential psychological disabilities and conditions, psycho-social concerns, as well as physical co-morbid concerns of employees/claimants/insured/patients. Additionally, a psychological model framework based upon evidence-based psychological diagnosis, use of objective, standardized psychological testing, and best-practice treatment guidelines is incorporated into the software. The software also includes code for generating data outputs to help users evaluate and manage a subject's psychological, psycho-social, and/or co-morbid physical disabilities according to the psychological model framework in view of data collected by the database and interface.

### BRIEF DESCRIPTION OF THE DRAWINGS

FIGS. 1A-1D are a flowchart illustrating preferred embodiment psychological disability claim evaluation and management software of the invention;

FIG. 2A is a flowchart illustrating a psychological disability claim review process used in computer software according to an embodiment of the invention;

FIG. 2B is a continuation of the flowchart shown in FIG. 2A;

FIG. 3 is a flowchart illustrating an independent medical examination process used in computer software according to an embodiment of the invention;

FIG. 4 is a network diagram of a computer system capable of executing psychological disability claim evaluation and management software of an embodiment of the invention; and

FIG. 5 is an example user interface of a psychological disability claim evaluation and management software of an embodiment of the invention.

### DETAILED DESCRIPTION OF THE PREFERRED EMBODIMENTS

As used herein, “software” encompasses local and distributed software, and code can reside, for example on local computers, or be implemented in a client-server model on a local area network or a wide area network as well as a web-based server. Client server models can be distributed across intranets or extranets. More generally, “software” and “systems” of the invention can encompass electronic delivery of data, user interfaces, responses, queries, etc., via any platform, operating system, network, local computer, etc.

Software of the invention is applicable to a number of industries, including insurance companies, the field of law, the fields of medical, rehabilitation, and mental health, employers, personnel management companies and departments, and federal agencies, each of which can have different interfaces and features while having consistent case evaluation, treatment assessment, and management philosophy. Similarly, different professionals can be provided particular software embodiments of the invention, with different interfaces. For example, particular interfaces can be directed toward physicians, psychologists, physical therapists, occupational therapists, rehabilitation counselors, vocational rehabilitation counselors, attorneys, judicial personnel, case managers, etc.

Preferred embodiment software of the invention addresses both employee/insured/patient and agency/company/professional needs, and ensures that the employee/insured/patient is being seen by the appropriate professional and is receiving appropriate evidence-based treatment. It also addresses whether there is supporting objective psychological test data to support the claim. Preferred embodiment software also provides risk management for the treatment and claim process since it identifies psycho-social concerns as well as co-morbid physical concerns that impede resolution of the employee/insured/claimant/patient's diagnosed concerns. Additionally, the preferred embodiment software guides the obtaining and/or generation of appropriate documentation from treating providers, and effectively manages a case/treatment to facilitate the employee's/insured's/patient's return to work.

Preferred embodiment software of the invention incorporates a psychological model for the objective evaluation, assessment, and evidence-based treatment of workplace and personal life psychological, co-morbid physical, and psycho-social concerns. The software provides a framework for managing any recognized disabilities and functional impairments, and assists users of the software in an ultimate goal to facilitate an employee's/insured's/patient's return to work (whether to the original job or to a different job). The framework emphasizes appropriate, evidence-based psychological diagnosis, the utilization of objective, standardized psychological testing, and (best-practice guidelines) treatment.

Software of the invention provides a comprehensive psychological consultation and training to businesses and other professionals to manage workplace or personal life psychological, psycho-social, or co-morbid physical concerns effectively. In a preferred business method embodiment of the invention, software is made available to psychologists, psychiatrists, physicians, employers, occupational nurses, insurance companies, attorneys, federal agencies, physical therapists & occupational therapists, and rehabilitation professionals.

A preferred embodiment provides evidence-based treatment algorithms to make decisions regarding the approval and/or continuation of a psychological disability claim (including one that is based primarily on psycho-social issues), or with a physical disability claim in which there is a concurrent psychiatric concern or a method of providing current best practice or evidence-based standards to treating professionals. In addition, the software is supported by the current randomized controlled trial research to denote present best practice standards.

A database is regularly updated in which subscribers to the software product can complete their own research specific to particular psychological diagnosis. There are specific algorithms for each psychological diagnosis. This information is preferably updated regularly to prevent outdated information being utilized by users. Specifically, the software includes evidence-based treatment algorithms that provide the mechanism in which to make decisions regarding the current status of a claim as to whether there are sufficient objective data to support the claim or to deny, if not supported. In addition, each of the products is designed to help the professional in making evidence-based decisions in the evaluation and treatment process. It is not meant to provide treatment, but rather to recommend evidence-based standards that are pertinent to specific diagnoses.

Embodiments of the invention can provide a number of advantages including: Access to an up-to-date database regarding psychological, psycho-social, and co-morbid physical concerns to provide current evidence-based information; Ability to track individual claims in real-time; Elements of claim (employee/insured/patient) information can be exported into existing organization software or information from organization software can be imported into the tool for complete tracking capabilities; Ability to track the length of claim from initiation to the closing of the claim/treatment plan/leave; Allows professionals to flag aspects of the claim in order to return to specific claim/treatment plan/leave elements in the future. Thus, it is not necessary to repeatedly review the claim/treatment plan/leave comprehensively each time the tool is opened; A way to communicate with employee/claimant/insured/patient about specific information required for claim; a way to communicate with treating professionals to gather essential information to help the employee/claimant/insured/patient return to work; permit gathered information to be printed in a report that can utilized both internally within the organization, and externally, such as in a legal procedure; and the ability to track claim/treatment/leave expenses, specific to the individual, specific category of diagnoses, medical and psychological treatment expenses, graduated return to work process, and collective time absent from work. In addition, the software provides a platform and interface to access a claim/treatment plan/leave either at its initiation or retroactively, if the claim/treatment plan/leave is already open.

Specific preferred embodiments of the invention will now be discussed. An example software framework for a preferred embodiment is provided in the attached drawings. A preferred psychological model is incorporated in the software and is discussed in the following text. The discussion of the preferred embodiments also guides the considerations to implement a particular coding strategy for preferred embodiment software of the invention, and artisans will appreciate that different software architectures can be used to implement the preferred embodiments.

An embodiment of the software for psychological disability evaluation and management is stored on a computer-readable memory, such as a magnetic disk, an optical disk, a magneto-optical disk, a read only memory (ROM), a random access memory (RAM), a flash memory, or the like.

The software includes a database interface for accessing a database that collects and manages information related to psychological disabilities and conditions, as well as psycho-social and physical co-morbid concerns for a subject. The database is maintained regularly and can be accessed by the software of the invention. The database conforms to all applicable Health Insurance Portability and Accountability Act (HIPAA) regulations, as well as any applicable federal and state laws.

The software preferably also includes another database interface for accessing a research database that allows the user to index and view current empirical research regarding pertinent information about factors of a psychological disability claim. For example, the user can complete Boolean searches of psychiatric diagnoses, co-morbid physical and psychological concerns, current medications utilized to treat specific psychiatric concerns, appropriate psychological/psychiatric assessment and evaluation, information pertaining to psychological tests, current evidence-based treatments for psychiatric concerns, costs and savings realized pertaining to diagnoses, epidemiology, prevalence rates, and the like. The empirical research stored in the research database is regularly updated to he ensure that the factual, evidence-based research remains current. The user can access and utilize the research regarding the disability management and prevention process to more effectively manage the process in an objective manner.

The preferred embodiment software also has a psychological model framework based on evidence-based psychological diagnosis and best-practice treatment and assessment guidelines, and an output module that contains code for generating data outputs to assist the user in evaluating and managing psychological, psycho-social, and co-morbid physical disability according to the psychological model framework, in light of the collected information relating to the subject. The software also provides a user interface designed to allow a user to interact with the software. The user may be an is employer, a mental health/psychological professional, a physician, a private or government agency official, a lawyer, an insurance professional, a rehabilitation counselor, a physical or occupational therapist, or any other person/professional involved in psychological disability evaluation and management. Similarly, the subject may be, for example, an employee, a claimant, and insured person, or a patient, or any other person undergoing psychological disability evaluation and treatment.

The software preferably has another, separate interface for use by a physician, psychologist, physical or occupational therapist, rehabilitation counselor, attorney, judicial personnel, insurance professional, or case manager, which provides additional functions. Generally, the software is executed by a computer system, aiding the user in managing and evaluating various psychological disability claims.

The preferred embodiment software allows for statistics of current and terminated claims to be tracked in a number of ways, both individually and in groups. To achieve this, the software provides the database with data regarding at least claim duration, type of diagnosis, expenses associated with the claim, treating professionals, and the age, gender, and occupation of the claimant. Accordingly, statistics for individual claims can be tracked by, for example, claim length, diagnoses (current or past), co-morbid concerns (i.e., physical injury or illness), job title, past claims, claim expenses, length of workplace absence, treating professional, type of occupation, gender of claimant, length of claimant's employment, age of claimant, claimant risk level, location (branch, department, section, region, city, state, country), and the like. Similarly, statistics for grouped claims can be tracked by at least type of diagnosis, current claims, co-morbid concerns (i.e., physical injury or illness), job title, past claims, length of claims, claim expenses, workplace absence (average for each individual or aggregate), treating professional, organization offices, occupation type, gender, length of current employment, claimant age, risk level, and location (branch, department, section, region, city, state, country). Thus, the software is a useful tool for a user analyzing trends within the received claims.

The software preferably also includes communication interfaces that allow the software to communicate with interested parties. For example, the software preferably has a first communication interface to facilitate communication between the software and the subject, and a second communication interface to facilitate communication between the software and the treating professionals. The communication preferably takes place over a network connection. For example, communication can take place via email or other electronic messaging system. These communication interfaces allow the user to quickly and efficiently alert the subject and/or treating professionals of any development regarding the evaluation.

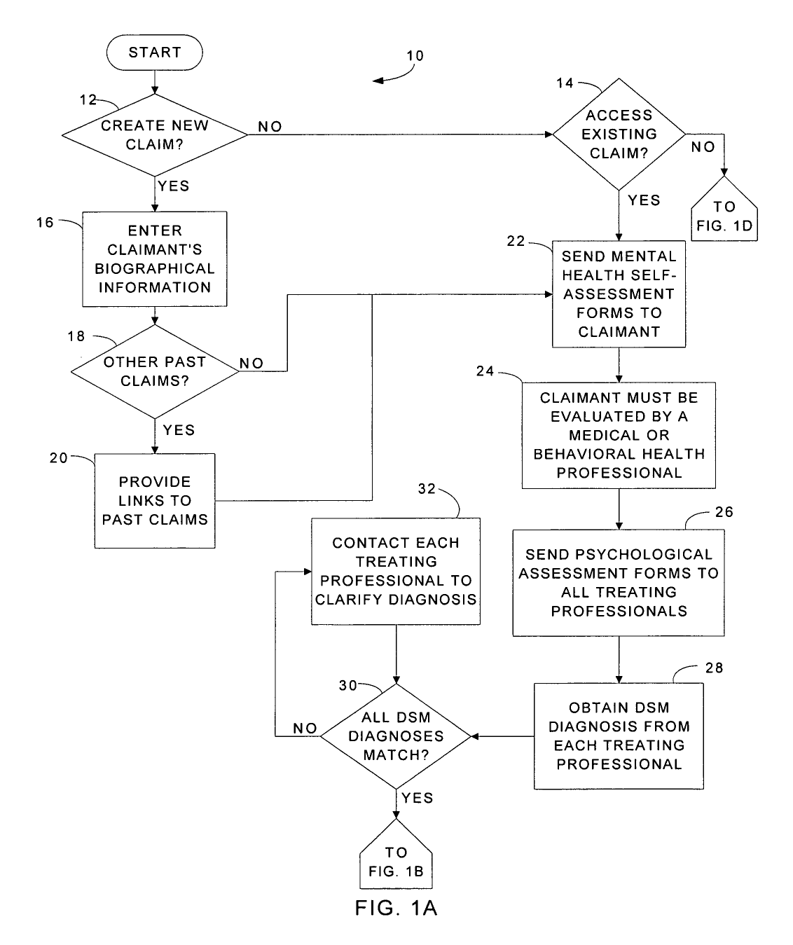

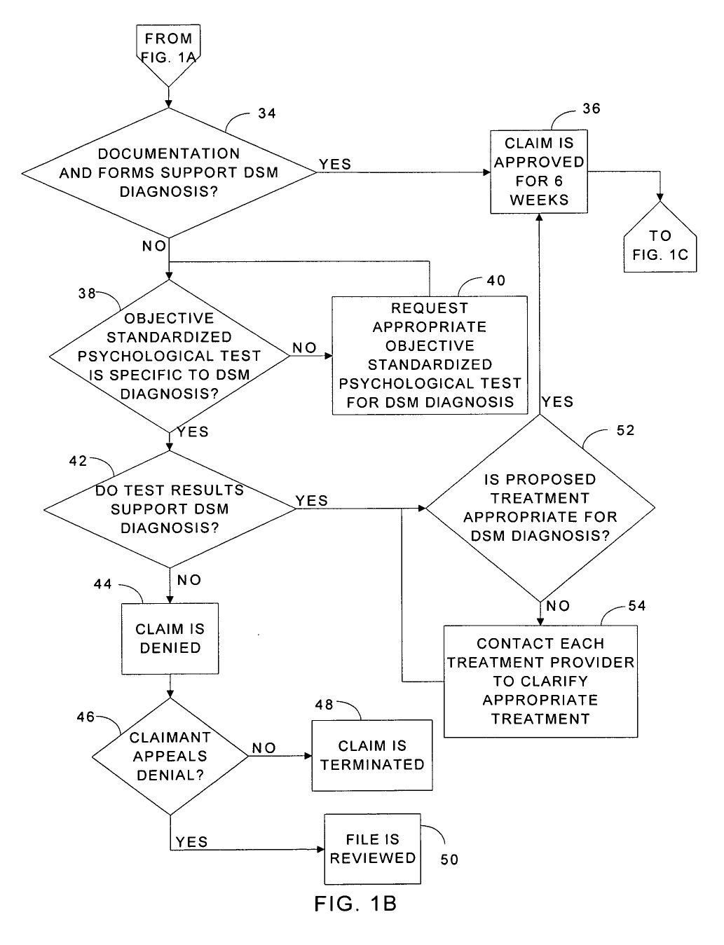

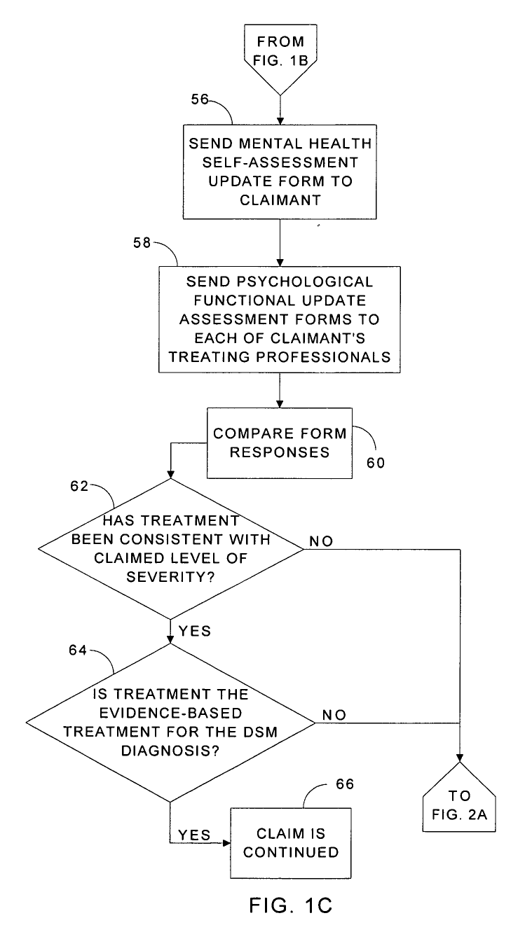

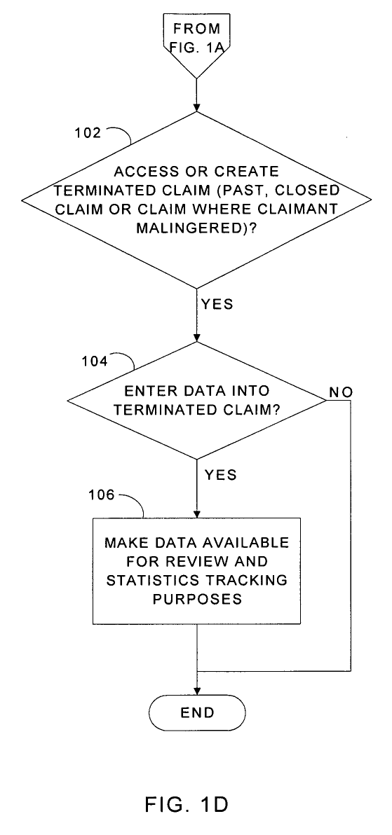

Referring now to FIGS. 1A-D, a flowchart illustrating preferred embodiment psychological disability claim evaluation and management software and user interaction with the software, is designated generally at 10. Initially, a user is provided a graphical interface that aids the user in claim evaluation and/or management. In step 12, the user is queried, such as through a dialogue box, to see whether a new claim is to be created, and the software 10 accepts user input regarding whether a new claim is to be created or not. If not, in step 14, the user is presented with dialogue to access an existing claim. If the user is creating a new claim (YES in step 12), the user enters biographical information related to the claimant (i.e., the subject) into the software database through the user interface in step 16. In step 18, the software 10 checks the entered information against other database entries to see if the claimant has past claims. If past claims exist, the software 10 provides the user with links to any other claims involving the claimant in step 20.

Whether there are past claims or not, in step 22, the software generates a mental health self-assessment form to be filled out by the claimant or during an interview with a claimant by a professional. The mental health self-assessment form is preferably presented as part of a graphical user interface with queues and dialogue boxes for pertinent information to be entered. Then in step 24, the software indicates to a user that the claimant is to be evaluated by a medical behavioral health professional. Appropriate treating professionals include, for example, an occupational medicine physician, a clinical psychologist, a licensed psychologist, a psychiatrist, or a primary care physician, provided no state or federal law or professional standard prohibits the treatment. Additionally, psychiatric nurses, nurse practitioners, licensed clinical social workers, licensed clinical professional counselors, and licensed professional counselors may serve as treating professionals, but generally do not have professional training in disability management and/or are not licensed to administer and interpret objective standardized psychological tests.

In step 26, psychological functional assessment forms to be filled out by all medical or behavioral health professionals involved in evaluating the claimant (collectively, “treating professionals”) are generated by the software. This preferably involves providing electronic assessment forms to professionals that have conducted the assessment. A system operating the software, for example, can provide electronic interaction with professionals via a personal computer or via mobile terminals as are used in hospital networks. The electronic assessment form guides the professional through completing the form. The claim is not approved or denied until all forms (mental health self-assessment and psychological functional assessment) have been returned, unless the claimant is hospitalized at the time the claim is made. If the claimant is hospitalized, the claim is approved until the claimant is released from hospitalization.

Data from the forms is received through the software and stored into a database. Received data from each treating professional should include, among other things, behavioral and cognitive assessments of the subject, a global assessment of functioning score, and activities of daily life functioning. The software reviews the received data from both the mental health self-assessment form and the psychological functional assessment forms for co-morbid physical concerns and/or disorders.

The software also accepts, in step 28, diagnoses from each of the treating professionals. The software includes interfaces and menus to guide the professionals in providing the diagnoses to ensure that the behavioral health professionals diagnose the claimant according to the Diagnostic and Statistical Manual of Mental Health Disorders, 4^{th} Edition, Text Revision or a subsequently approved edition, The International Classification of Diseases, 9^{th} Revision or subsequently approved criteria, or other current diagnostic criteria (hereinafter, “DSM”). The software can present menus with lists of suggested diagnoses based upon data that has been received regarding the claimant, but does not accept diagnoses that fail to meet the DSM. For example, “stress” would be an unacceptable psychological diagnosis because, according to the DSM, stress is a normal part of life and cannot be eliminated. On the other hand, diagnoses such as major depressive disorder, dysthymic disorder, bipolar disorder, generalized anxiety disorder, panic disorder, obsessive-compulsive disorder, social phobia, and posttraumatic stress disorder are recognized by the DSM as psychological disorders, and thus are examples of acceptable psychological diagnoses. In step 30, the software determines whether the DSM diagnoses from multiple treating professionals are the same. If the diagnoses do not match, in step 32 a treatment manager is directed by the software to contact each of the behavioral health providers to clarify their diagnoses until a consensus is achieved. If a treating professional disagrees with the diagnosis of other professionals, the dissenting professional's diagnosis is reviewed. Once a consensus is reached regarding the DSM diagnosis, the software presents an appropriate treatment algorithm, allowing the user to review the evidence-based best practice standard for the DSM diagnosis.

Referring now to FIG. 1B, with respect to each consensus DSM diagnosis that is received regarding a particular claim, the software examines the data related to the claim and determines, in step 34, whether the data received into the database from the mental health self-assessment and psychological functioning assessment forms provides sufficient objective evidence to support the claim (i.e., the DSM diagnosis). If the DSM diagnosis is supported, the claimant's claim is approved for a set time period in step 36. The period of time will depend upon the nature of the particular diagnosis. For example, the claim may be approved for 6 weeks for a diagnosis of Major Depressive Disorder.

If the data obtained by the software through the documentation and forms do not support the claim, the claim is provisionally denied. At this time, the claimant and treating professionals are contacted, and the software directs that objective psychological testing specific to the DSM diagnosis to be administered according to American Psychological Association (APA) guidelines for testing, assessment and treatment planning. A professional user can select, through an interface with the software, a proposed objective test(s). Then, in step 38, the software determines whether the proposed psychological testing is sufficient objective testing specific to the DSM diagnosis. If not, the software suggests, in step 40, appropriate testing corresponding to the claimant's DSM diagnosis.

Normative assessment tests are generally preferred to Ipsative assessment tools, and are used for the sufficiency test in step 38 and for the suggestions generated by the software in step 40. Normative assessment tests are designed to compare an individual's score on particular clinical concern or behavior to a reference group, with an average score of the reference group designated the norm. Norms allow standardized scores to be calculated. This provides information about how the individual performed compared to the norm, and allows for unusual responses/behaviors to be identified. On the other hand, Ipsative assessment tools generally allow the ability to track change within a subject, but do not provide information about how one test subject's score relates to others. Additionally, Ipsative assessment tools typically lack validity measures. Table I shows examples of DSM diagnoses and acceptable objective tests and data that can be reference by the software.

TABLE I
Examples of Appropriate Objective Standardized Psychological Tests, by
DSM Diagnosis
Tests may be added or deleted in accordance with current professional
guidelines.

| | Acceptable Objective Psychological |
|---|---|
| Disorder | Tests |
| Major Depressive Disorder | Behavior Health Inventory |
| | Minnesota Multiphasic |
| | Personality Inventory |
| | Millon Clinical Multi-Axial |
| | Inventory |
| | Personality Assessment |
| | Inventory |
| Dysthymic Disorder | Behavior Health Inventory |
| | Minnesota Multiphasic |
| | Personality Inventory |
| | Millon Clinical Multi-Axial |
| | Inventory |
| | Personal Assessment Inventory |
| Anxiety Disorders, including: | Behavior Health Inventory |
| posttraumatic stress disorder, | Minnesota Multiphasic |
| general anxiety disorder | Personality Inventory |
| panic disorder | Millon Clinical Multi-Axial |
| social phobia | Inventory |
| obsessive-compulsive | Personality Assessment |
| disorder | Inventory |
| Personality Disorders | Minnesota Multiphasic |
| | Personality Inventory |
| | Millon Clinical Multi-Axial |
| | Inventory |
| | Personality Assessment |
| | Inventory |
| Bipolar Disorder | Millon Clinical Multi-Axial |
| | Inventory |
| | Minnesota Multiphasic |
| | Personality Inventory |
| | Hare Psychopathology Checklist |
| | Personality Assessment |
| | Inventory |
| Cognitive Impairment | Boston Naming Test |
| Neuropsychological Concerns | Benton Series (e.g., Benton |
| Memory Concerns | Visual Retention Test) |
| | Booklet Category Test |
| | Colors Trails Test |
| | California Verbal Learning Test |
| | Comprehensive Trail Making |
| | Test |
| | Finger Tapping Test |
| | Grooved Pegboard |
| | Hand Dynamometer |
| | Memory Assessment Scale |
| | Neuropsychological Assessment |
| | Battery |
| | Rey Auditory Verbal Learning |
| | test |
| | Rey Complex Figure Test and |
| | Recognition Trial |
| | Rey-Osterrieth Complex Figure |
| | Stroop Test |
| | Test of Memory and Learning |
| | Trail Making Test |
| | Full-Scale WAIS-III (beginning |
| | 9/08, WAIS-IV) |
| | Wechsler Memory Scale-III |
| | (beginning 12/08, WMS IV) |
| | Wisconsin Card Sorting Test |
| | Wide Range Assessment of |
| | Memory and Learning |
| | Wide Range Achievement Test 4 |
| Biopsychosocial Concerns | Behavior Health Inventory |
| | Millon Behavioral Medicine |
| | Diagnostic |
| | Minnesota Multiphasic |
| | Personality Inventory |
| | Plan Patient Profile |
| | Personality Assessment |
| | Inventory |
| | Hare Psychopathology Checklist |

Preferably, the software directs the treating professional to administer at least two tests that assess the validity of the claimant's test responses. Tests such as the Malingering Probability Scale, Structured Inventory of Malingering Symptomology, Structured Inventory of Reported Symptoms, Test of Malingered Memory, Validity Indicator Profile, and Victoria Symptom Validity Test meet this requirement, for example. This listing is not all-inclusive, and can change as new tests are developed and supported by empirical research. Once all appropriate tests have been administered, the results of the psychological testing, including profile numbers, validity indices, T scores, base rates, critical item scores, scale scores, percentiles, ranks, cutoff scores, raw scores (when appropriate) and the like are input into the software using the user interface. In step 42, the software, which includes or accesses tables having a list of DSM diagnoses correlated with appropriate tests and test results, determines whether the input test results are valid, and whether the stored test results support the stored DSM diagnosis made by the behavioral health professionals.

If the test results do not support the DSM diagnosis, the software suggests that the claim be denied in step 44. At that point, the claimant may appeal the denial or allow the claim to be terminated. The software determines whether the claimant has filed an appeal in step 46. As stated above, if no appeal is filed, the claim is terminated in step 48. If the claimant does file an appeal, the software directs that the claimant's file be reviewed in step 50. This step, as with any of the steps seeking user or professional input, can provide notifications to the user or professional via the user interface, e-mail, mobile terminal, calendar entry, etc.

On the other hand, if the test results do support the DSM diagnosis in step 42, the software accepts a proposed treatment and determines whether the proposed treatment is appropriate for the DSM diagnosis in step 52. If not, the software directs the user to contact each of the medical or behavioral health professionals in step 54, or provides electronic notices of the type discussed in the previous paragraph, seeking input of the professionals to clarify the treatment and make any necessary changes. Once the software determines that the stored test results support the stored psychological diagnosis and the proposed treatment is deemed appropriate, the process moves to step 36, the software indicates that the claim is allowed, and the claim is approved for the appropriate a fixed period, for example, 6 weeks, such as with a diagnosis of Major Depressive Disorder.

As shown in FIG. 1C, once a claim is approved, the claimant undergoes treatment during the approved period. Then in step 56, near the end of the approved period (e.g., one week prior to the end of the approved period), the software is used to generate and send a mental health self-assessment update form to the claimant, for example via e-mail, mail, secure web page, etc., and in step 58 psychological functional assessment update forms are generated by the software and sent to all treating professionals, preferably by convenient electronic transmission or request. The treating professional provides updated data, including an updated diagnosis, updated global assessment of functioning score, and updated activities of daily life functioning information, as well as updated behavioral and cognitive professional opinions. Any supporting objective data, such as objective psychological testing is provided by the treating professional as well. Data from the completed update forms is received into the software and compared in step 60.

In step 62 it is determined whether the treatment provided to the subject is consistent with the claimed severity level of the psychological disorder. Forth provided treatment to be consistent with the claimed severity level, the claimant should see a psychiatrist on at least a weekly basis. If the claimant refuses to see a psychiatrist, the claim is put on hold. The claimant should also receive psychotherapy from a licensed clinical psychologist. If the claimant does not have a treating psychologist and psychiatrist, the software can be used to locate treatment professionals that will suit the needs of the claimant. Also, during treatment, the treating professionals should provide objective psychological test results and other information regarding the claim, including updated diagnoses, cognitive and psychological functioning, global assessment of functioning scores, and the like.

Based on these test results, as well as the mental health self-assessment update form and the psychological functional assessment update forms, the software evaluates the claim based on a checklist shown in Table II.

TABLE II
Claim Evaluation Checklist

| | |
|---|---|
| 1) | Discrepancies between initial Mental Health Self-Assessment form |
| | and Mental Health Self-Assessment Update form. |
| 2) | Discrepancies between the claimant's information on Mental Health |
| | Self-Assessment forms (both) & the treating professional's |
| | Psychological Functional Assessment and Update forms. |
| 3) | Discrepancies between each treating professional's Psychological |
| | Functional Assessment & Update forms. |
| 4) | Lack of Communication between treating professionals. |
| 5) | Current treatment is not evidence-based and/or isn't specific to DSM |
| | diagnosis. |
| 6) | The DSM diagnosis has changed. |
| 7) | Concerns noted are primarily psychosocial, such as work or personal |
| | life concerns (e.g., stress) |
| 8) | Claimed functional impairments are not consistent (e.g., claimant is |
| | noted to be able to live alone, but is not able to shop for food, pay |
| | bills, prepare meals, care for children, etc.). |
| 9) | Symptoms are not consistent with restrictions (e.g., Claimant is |
| | noted to be suicidal, have cognitive impairment, or has poor |
| | judgment, but is permitted to drive by the treating professional). |
| 10) | Return to work has not been discussed. |
| 11) | Return to work is not a part of the treatment plan. |
| 12) | A return to work date has not been set. |
| 13) | Claimant has filed multiple claims in the past. |
| 14) | Claimant or treating professional notes that the workplace must make |
| | substantial changes before the claimant can return to work. |
| 15) | The treating professional notes a lengthy workplace absence without |
| | documentation or regard for current best practice standards. |
| 16) | Claimant notes improbable symptoms occurring with diagnosis. |
| 17) | Claimant has a physical concern that limits the individual's physical |
| | functioning. |
| 18) | No objective psychological testing has been completed to adequately |
| | evaluate the claimant's psychological symptoms. |
| 19) | Inappropriate psychological tools or surveys are provided by the |
| | treating professional as proof of psychological impairment. |
| 20) | Invalid psychological test results are provided by the psychologist as |
| | supportive evidence of psychological impairment. |
| 21) | Psychological test results and data are supportive of symptom |
| | exaggeration. |
| 22) | Psychological test results and data are supportive of malingering |
| | (results in automatic claim denial). |
| 23) | Cognitive impairment is noted by treating professional, but no |
| | objective psychological testing has been completed. |
| 24) | Treating professional's documentation appears to be exaggerated or |
| | inconsistent with severity of claim. |

If five or more concerns from the checklist of Table II are identified within the claimant's file there is significant potential that psychosocial concerns are occurring rather than psychological concerns. Thus, each of the identified concerns identified from the checklist in Table II should be resolved by a peer-to-peer review involving the user and the treating professional. Next, in step 64, it is determined whether the treatment is an evidence-based treatment appropriate for the DSM diagnosis. If the treatment is an appropriate evidence-based treatment, then in step 66 the claim is continued, for example, for another 4 weeks. The same update process takes place one week prior to the end of the extended claim period, and the claim may be extended for up to an additional two weeks, so that the aggregate claim period does not surpass a total of 12 weeks. The majority of psychological concerns can be resolved within this 12 week time frame. Thus, if a subject is still incapacitated after 12 weeks have elapsed, an independent medical examination is scheduled.

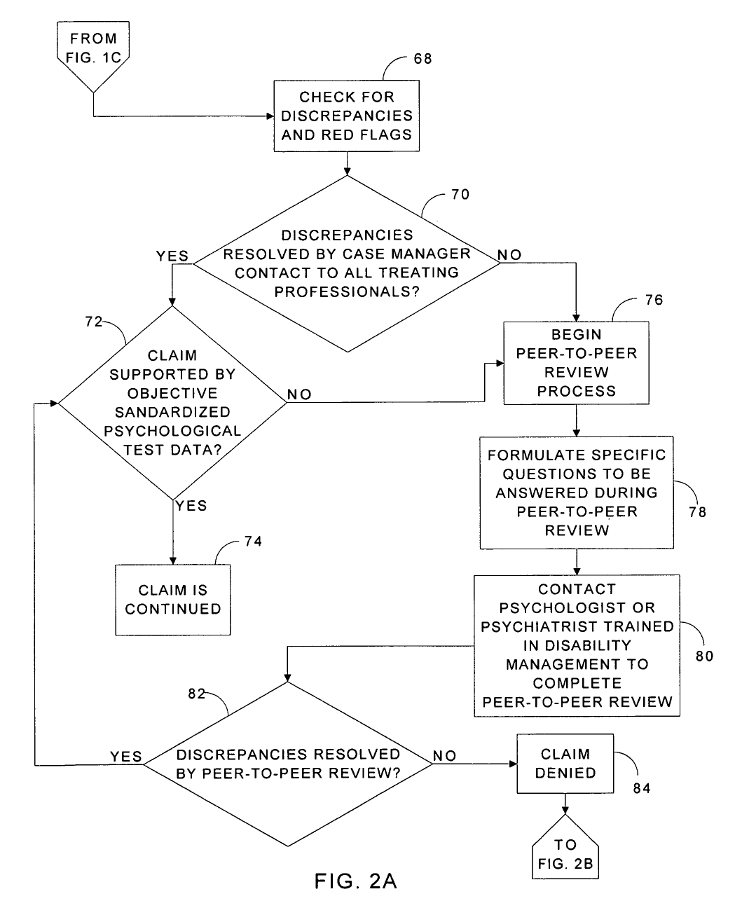

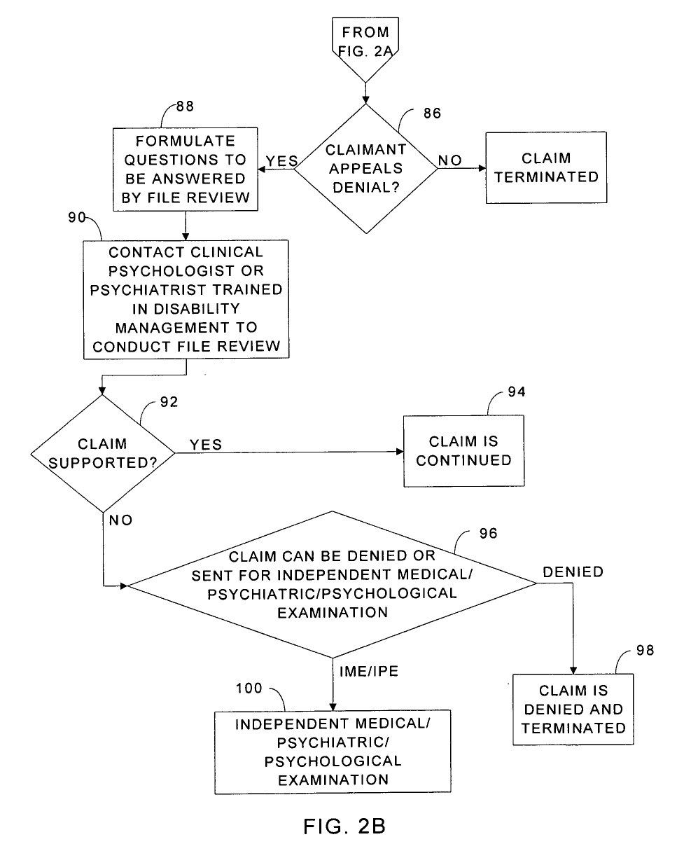

Referring now to FIG. 2A, if the provided treatment is not consistent with the claimed severity of the disorder, is not an evidence-based treatment of the DSM diagnosis, or if multiple discrepancies are noted between the claimants update form and the treating professionals' update forms, the claim is analyzed by the software in step 68 for various discrepancies and “red flag” events. Red flag events include discrepancies between the claimant's update form and the treating professionals' update form or among treating professionals' update forms, lack of communication between treating professionals, invalidity or absence of objective psychological test data, provided treatment that is not evidence-based treatment specific to the DSM diagnosis, inconsistency between claimed impairments and the claimant's ability to live independently, lack of a return to work (RTW) date, multiple claims initiated by the claimant, symptom exaggeration, and the like. These flags all serve as risk management identifiers and alert the user to the need for additional objective information. The user interface of the software also permits the user to manually flag any additional problematic information related to the claimant. Additionally, the file is reviewed for malingering. If malingering is found, the claim is automatically denied. A preferred embodiment of the software also presents the user with information regarding psychotropic medications that are commonly used for the DSM diagnosis, including starting dosages, maximum dosages, and when the prescribed dosage can be increased safely. This information regarding typical prescriptions allows the user to compare the claimant's actual prescription with a typical prescription.

If discrepancies and/or red flags are identified, the claim should be marked for increased risk and case management because there is an increased risk that the claimant's recovery period will be longer than typical. The information from both the mental health self-assessment form and the psychological functional assessment forms is also examined for any psychosocial issues. A partial list of signs indicating that psychosocial issues may be influencing the claim process is provided in Table III. Again, all discrepancies, red flags, and psycho-social issues are flagged by the software for risk management and additional objective supporting data.

TABLE III
Signs that Psychosocial Issues May be Influencing the Claim Process

| | |
|---|---|
| 1) | Claimant claims s/he can't work, but can complete multiple activities of |
| | daily living. |
| 2) | Claimant claims to have significant memory and concentration difficulties, |
| | but can drive a car. |
| 3) | Symptoms continue despite negative medical findings (absence of any |
| | objective physical or psychiatric findings). |
| 4) | Claimant reports extreme or highly improbable symptoms. |
| 5) | Claimant complains of symptoms that generally exceed what is expected |
| | with the objective medical or psychiatric findings. |
| 6) | Significant delays in recovery that cannot be explained in context of the |
| | concern. |
| 7) | Standardized objective psychological testing demonstrates significant poor |
| | motivation or poor test effort by the claimant. |
| 8) | Claimant does not comply with treatment. |
| 9) | Claimant does not make any changes in lifestyle. |
| 10) | Claimant reports that s/he has not received any relief from any treatment. |
| 11) | Claimant has significant emergency department visits. |
| 12) | Claimant has filed for disability in the past. |
| 13) | Claimant does not want to be examined physically or psychologically (may |
| | either refuse or minimally participate in examination). |
| 14) | Claimant demonstrates significant muscular bracing. |
| 15) | Claimant reports significant sleep concerns. |
| 16) | Claimant has a significant weight fluctuation, either increase or decrease. |
| 17) | Claimant has symptoms that are stress-related. |
| 18) | Claimant does not utilize medications as prescribed, in particular, with pain |
| | or psychotropic medications. |
| 19) | Claimant reports poor coping strategies. |
| 20) | Claimant is self-medicating with legal or illegal substances/drugs. |
| 21) | The mental health self-assessment and psychological functional assessment |
| | forms demonstrate multiple stressors occurring in the claimant's life. |
| 22) | Claimant has been diagnosed with an Axis II (developmental disorder or |
| | personality disorder) concern. |
| 23) | Claimant reports significant workplace stressors (i.e., conflict with |
| | supervisor or co-workers) or stressful job demands. |
| 24) | Multiple workplace illness absences. |
| 25) | Timing of claim after negative work evaluation or reprimand. |
| 26) | Claimant reports conflict between work and personal/family life. |
| 27) | Claimant reports significant personal life stressors. |
| 28) | Claimant holds another job or is self-employed. |
| 29) | Claimant is going to school while on disability leave. |
| 30) | Claimant claims to be unable to complete most activities of daily living, but |
| | reports s/he can take care on his/her own children. The only situation where this |
| | would not be significant is when the children are over the age of 16 and are able to |
| | take care of basic activities of daily living with some independence. |

If discrepancies or red flags are found, the software directs a case manager in step 70 to contact the treating professionals (or the software initiates the contact) to gather additional information and resolve the discrepancies. If all discrepancies can be resolved, the software determines in step 72 whether the claim is supported by objective test data. Assuming the claim is supported by the test data, the claim is continued in step 74.

When all discrepancies cannot be resolved by the case manager (NO in step 70) or the claim is not supported by objective test data (NO in step 72), the software directs commencement of a peer-to-peer review. The peer-to-peer review is started in step 76. In step 78, the user may use the software and the materials stored in the database to formulate specific questions to be answered during the review. Then, in step 80, a clinical psychologist or psychiatrist trained in Disability Management reviews the file in an effort to resolve the discrepancies. In step 82 the software determines whether the discrepancies identified in step 68 have been resolved through the peer-to-peer review process. If the discrepancies are resolved, the software determines whether the claim is supported by objective data in step 72. If the claim is supported, the claim is continued in step 74, as described above. On the other hand, if the discrepancies are not resolved through peer review, the claim is denied in step 84.

After a claim is denied in step 84, the claimant may choose to appeal the decision. In step 86, it is determined whether the claimant has appealed the denial. When a claim is appealed, specific questions are formulated by the software to facilitate a file review in step 88, in a manner similar to peer-to-peer review. Then in step 90, a clinical psychologist or psychiatrist trained in Disability Management completes the file review and the results of the review are received by the software and stored in the database accessed by the software. In step 92, the software determines whether the claim is supported by data in the claimant's file that is stored in the database. If the claim is supported, the claim is continued in step 94. Otherwise, at step 96, the user determines whether the claim is denied (and therefore terminated) as in step 98, or sent for an independent medical or psychological/psychiatric examination as in step 100.

Referring back to FIG. 1D, the user may also choose to access or create a terminated claim (i.e., a past claim, or a claim in which the claimant malingered) at step 102. When creating a terminated claim, the user is prompted by the software at step 104 to determine whether any claim data will be entered into the terminated claim. If the user chooses to enter claim data, the entered data is made available for purposes of review and statistics tracking in step 106. Thus, entering claim data advantageously creates a full record of the terminated claim, and allows the claim to be analyzed using the software and to track claims by diagnosis, treating providers, cost, duration, or the like. However the user may decide that claim information should not be entered into the database during this session. For example, the claim data may have already been entered during a previous session, or the user may be using another system to track the terminated claim. Accordingly, entry of claim information is not required for terminated claims.

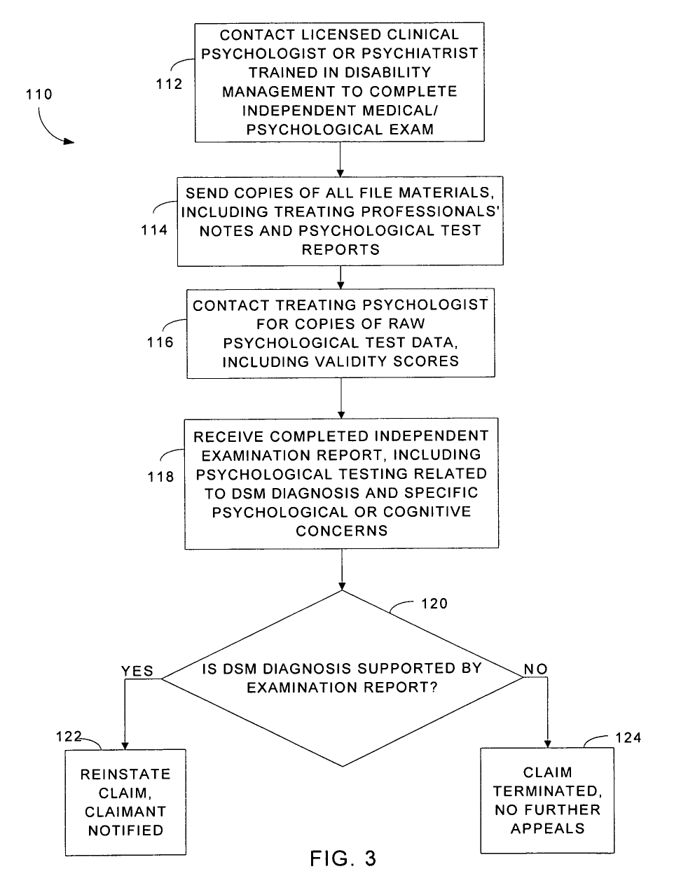

Referring now to FIG. 3, an independent medical/psychological/psychiatric examination process is designated generally at 110. In general, the process is similar to the peer-to-peer and file review processes described above. In step 112, a licensed clinical psychologist or psychiatrist trained in Disability Management is contacted by the user or by the software with a request to schedule an independent examination. Next, the software is used to generate copies of all file information relating to the claim, including the treating professionals' notes, and psychological test results in step 114. Additionally, in step 116, all treating psychologists are contacted, and copies of raw data, including validity scores/indices, from all psychological tests that were conducted are obtained. The user formulates specific question to be answered by the independent review. Then, the licensed clinical psychologist or psychiatrist independently reviews the file and the subject.

The user receives, in step 118, a completed independent examination report that includes objective psychological testing results related to the DSM diagnosis and any specific psychological or cognitive concerns the reviewing psychologist or psychiatrist may have, and the results are input into the software. Then, in step 120, the software is used to determine whether the DSM diagnosis is supported by the received independent examination report. If the diagnosis is supported by the report, the claim is reinstated in step 122, and the claimant/subject is notified. Alternatively, if the examination report does not support the diagnosis, the claim is terminated in step 124. No further appeal is permitted after an independent medical/psychological examination.

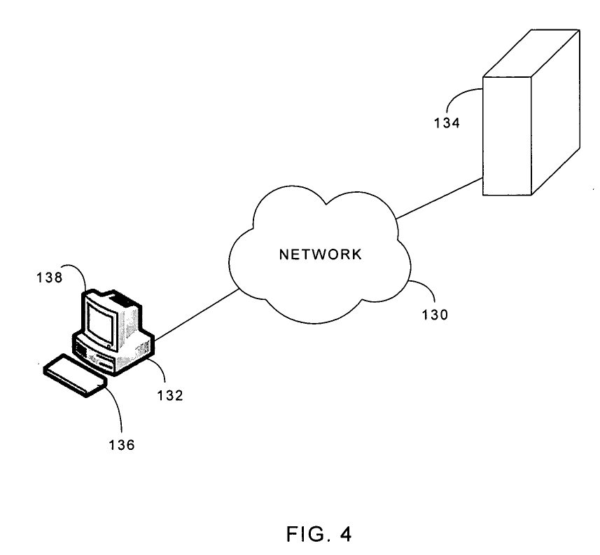

Referring now to FIG. 4, a computer network is designated at 130. The network may be, for example, a local area network or the Internet. Connected to the network 130 is a computer system including a client 132 and a server 134. While the illustrated network shows only a single terminal, it is contemplated that multiple clients 132 may be connected to a single server 134 via the network. It is also contemplated that a single personal computer could serve as both the server 134 and a client 132. The client 132 may be, for example, a personal computer, a thin client, or a mobile terminal such as those used in a hospital network. The client 132 includes at least one user input device 136, such as a keyboard, mouse, touch-sensitive screen, or the like, and a display device 138, such as a monitor. The display device 138 receives output data from an output module in the software, and creates a visual display of the output data (i.e., the user interface and any data to be displayed). Additionally, the client 132 stores and executes at least the software required to generate the user interface and to both send data to and receive data from the server 134. If the client 132 is a personal computer, the client also preferably contains and executes software for processing the data input through the input device 136 or received from the server 134.

The server 134 stores the database that maintains subject records and the research database. The server also contains and executes software for transmitting data to and receiving data from the client 132, and for updating the database based on data received from the client. Additionally, if the client 132 is a thin client, the server 134 preferably contains software for processing the data that is received from the client 132.

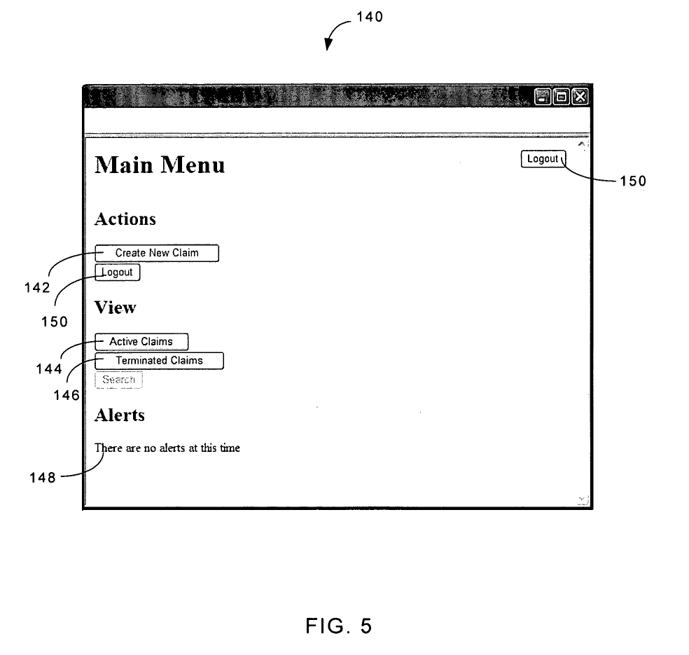

Referring now to FIG. 5, an example of a user interface of a preferred embodiment of the software being executed on a computer system is designated generally at 140. The interface 140 contains a create new claim button 142 that, when selected, allows the user to create a new psychological disability claim or treating information. An active claims button 144, and a terminated claims button 146 allow the user to view all active or terminated psychological disability claims, respectively. The alerts field 148 shows any alerts regarding active disability claims. Finally, the logout buttons 150 allow the current user to log out of the program.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. Software for psychological disability evaluation and management comprising:
at least one user interface geared specifically toward one or more of an employer, a psychological professional, a physician, an private or government agency or official, a lawyer; an insurance professional, a vocational rehabilitation counselor, a physical or occupational therapist, or another person or company involved in psychological, psycho-social, and co-morbid physical disability evaluation and management;
a database interface for accessing a database that collects and manages information relating to potential psychological disabilities and conditions, psycho-social concerns as well as physical co-morbid concerns of employees/claimants/insured/patients;
a psychological model framework based upon evidence-based psychological diagnosis, objective, standardized psychological testing, and best-practice treatment guidelines; and
code for generating data outputs to assist one or more users in evaluation and management of psychological, psycho-social, and co-morbid physical disability according to the psychological model framework in view of data collected by the database and interface.

2. The software of claim 1, having a specific separate interface for one or more of physicians, psychologists, physical therapists, occupational therapists, rehabilitation counselors, vocational rehabilitation counselors, attorneys, judicial personnel, case managers, and insurance professionals.

3. The software of claim 1, further comprising a test determining module which determines whether a proposed psychological test is an objective test specific to a given psychological diagnosis.

4. The software of claim 1, further comprising:
a first communication interface for transferring data to and from the employee/claimant/insured/patient; and
a second communication interface for transferring data to and from one or more treating professionals who are treating the employee/claimant/insured/patient.

5. The software of claim 1, wherein the at least one interface allows a user to flag problematic information related to the employee/claimant/insured/patient.

6. The software of claim 1, further comprising a second database interface for communicating with a second database that collects and stores information regarding relevant psychological research.

7. A computer-readable medium storing the software of claim 1.

8. A computer system executing the software of claim 1.

9. The computer system of claim 8, including a monitor for outputting the generated data outputs as a visual display.

10. Software for psychological disability evaluation and management comprising code for:
accessing a database that manages and stores information relating to one or more claims of psychological disability, including at least a patient name, a DSM psychological diagnosis, results of DSM diagnosis-specific, objective, standardized psychological tests, and a proposed treatment;
determining whether, for each patient, the stored test results support the stored psychological diagnosis;
determining whether, for each patient, the stored proposed treatment is appropriate for the stored psychological diagnosis outputting a claim status, wherein the claim status is indicated as allowed if the stored test results support the stored psychological diagnosis and the stored proposed treatment is appropriate for the stored psychological diagnosis.

11. The software of claim 10 wherein for each claim, the software provides the database with data regarding a duration of the claim, expenses associated with the claim, treating professionals associated with the claim, patient gender, patient age, and patient occupation.

12. The software of claim 11, further comprising code for a statistics tracking unit tracking statistics related to the one or more stored claims.

13. A computer-readable medium storing software according to claim 10.

14. A computer system executing the software of claim 10.

15. Software for psychological disability evaluation and management comprising:
code to generate self-assessment forms to be filled out by an employee/claimant/insured/patient;
code to generate assessment forms to be completed by a treating behavioral health professional;
code to compare assessment forms and self-assessment forms;
an output module indicating the status of a psychological disability claim

16. A computer-readable medium storing software according to claim 15.

17. A computer system executing the software of claim 15.

18. The computer system of claim 17, comprising a display device, wherein the output module creates a visual display on the display device.
